(19) United States
(12) Patent Application Publication
(10) Pub. No.: US 2006/0279864 A1
(43) Pub. Date: Dec. 14, 2006

(54) On structure of a side mirror

(76) Inventor: Wei-Pin Lee, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/151,450

(22) Filed: Jun. 14, 2005

(51) Int. Cl. G02B 7/182

(52) U.S. Cl. 359/879; 359/868

(57) ABSTRACT

A side mirror includes a main mirror facing in a substantially rearward direction, and subsidiary twin mirrors; the subsidiary twin mirrors are positioned under the main mirror, and include a supporting member, a first subsidiary mirror, and a second subsidiary mirror; the first subsidiary mirror is joined to, and adjustable in orientation in relation to, the supporting member for imaging a front wheel of a car and an area near to the front wheel; the second subsidiary mirror is joined to, and adjustable in orientation in relation to, the supporting member for imaging a rear wheel of the car and an area near to the rear wheel; thus, the blind areas, which can't be seen in the main mirror, are imaged on the subsidiary twin mirrors for the driver.

### BACKGROUND OF THE INVENTION

1. Field of the Invention

The present invention relates to a side mirror, more particularly one, which is structured in such a way that as to image the major blind areas for the driver, which can't be imaged in conventional side mirrors.

2. Brief Description of the Prior Art

Side mirrors are joined to lateral sides of cars for imaging the areas behind two sides of the cars for the drivers. Although most conventional side mirrors are wide-angle ones and adjustable in orientation, the following problems still exist when they are used:

1. The conventional side mirrors can image areas behind two sides of the cars, but the front wheels and areas near to the front wheels can't be imaged in the side mirrors, and will become blind areas in driving.

2. The conventional side mirrors can only image objects within a certain range. Therefore, there will be, beside the cars, smaller areas imaged on the side mirrors if the mirrors are adjusted in orientation such that rear lateral portions of the cars are imaged. Consequently, blind areas exist, and accidents are likely to happen in passing other cars on the road. And, rear lateral portions of the cars won't be imaged in the side mirrors if the mirrors are adjusted in orientation such that larger areas beside the cars are imaged. Consequently, the cars are likely to run into obstacles when the drivers are backing the cars into a garage or a parking area.

### SUMMARY OF THE INVENTION

It is a main object of the invention to provide an improvement on a side mirror to overcome the above-mentioned problem. The side mirror of the invention includes a main mirror facing in a substantially rearward direction, and subsidiary twin mirrors. The subsidiary twin mirrors are positioned under the main mirror, and include a supporting member, and first and second subsidiary mirrors. The first subsidiary mirror is joined to, and adjustable in orientation in relation to, the supporting member for imaging a front wheel of a car and an area near to the front wheel. The second subsidiary mirror is joined to, and adjustable in orientation in relation to, the supporting member for imaging a rear wheel of the car and an area near to the rear wheel. Therefore, the blind areas, which can't be seen in the main mirror by the driver, are imaged on the subsidiary twin mirrors for the driver.

### BRIEF DESCRIPTION OF THE DRAWINGS

The present invention will be better understood by referring to the accompanying drawings, wherein:

FIG. 1 is a horizontal sectional view of the first preferred embodiment of a side mirror in the present invention, installed on a car,

FIG. 2 is a horizontal section of the first preferred embodiment,

FIG. 3 is a front view of the first preferred embodiment,

FIG. 4 is a horizontal section of the second preferred embodiment,

FIG. 5 is a front view of the second preferred embodiment,

FIG. 6 is a horizontal sectional view of the third preferred embodiment, and

FIG. 7 is a horizontal section of the fourth preferred embodiment.

### DETAILED DESCRIPTION OF THE PREFERRED EMBODIMENTS

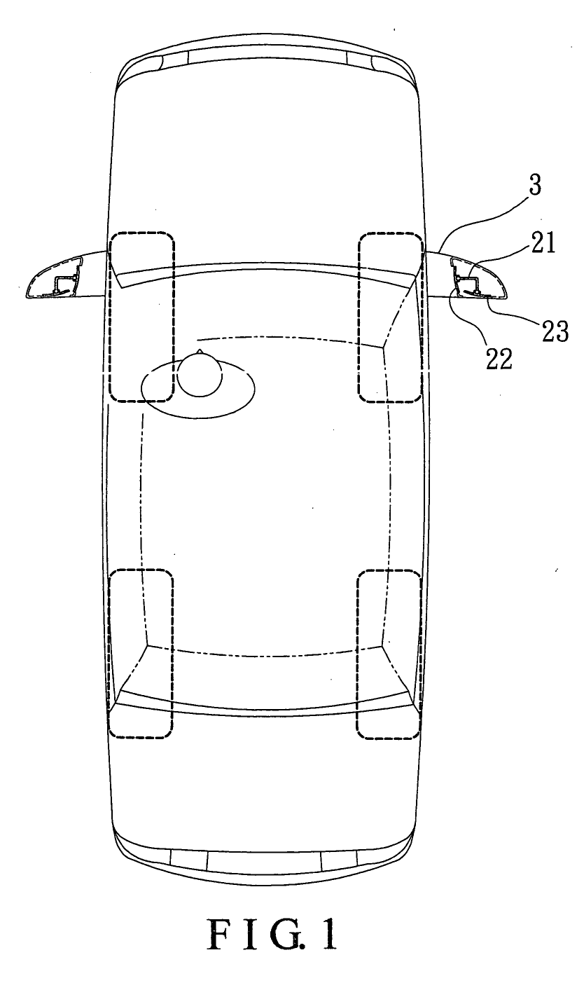

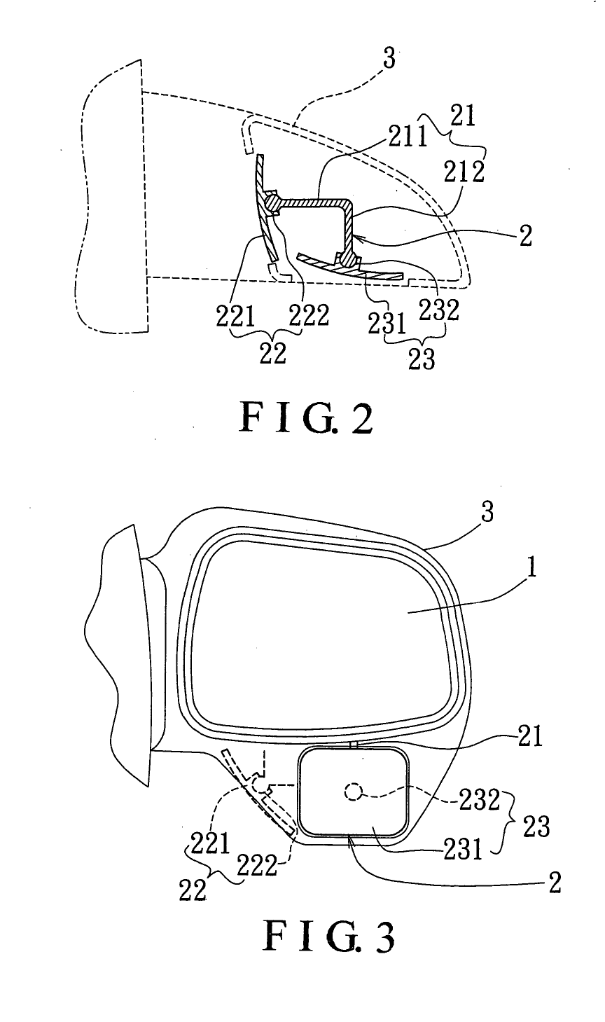

Referring to FIGS. 1 to 3, a first preferred embodiment of a side mirror includes a main mirror 1, subsidiary twin mirrors 2, and a cover 3.

The main mirror 1 is held in the cover 3. The subsidiary twin mirrors 2 include a supporting member 21, a first subsidiary mirror 22 for imaging a front wheel of a car and an area near to the front wheel, and a second subsidiary mirror 23 for imaging a rear wheel of the car and an area near to the rear wheel; the subsidiary mirrors 22, and 23 can be convex ones or lozenge ones. The supporting member 21 is disposed in and secured to the cover 3 under the main mirror 1. And, the supporting member 21 is preferably positioned nearer to an outward end portion of the main mirror 1. The supporting member 21 includes first and second supporting rod portions 211, and 212 pointing in different directions. The first subsidiary mirror 22 includes a mirror unit 221, and it is formed with a fitting cavity 222 on a rear side thereof. The first supporting rod portion 211 of the supporting member 21 is fitted in the fitting cavity 222 of the first subsidiary mirror 22 at a tail end such that the first subsidiary mirror 22 can be changed in orientation in relation to the supporting member 21. The second subsidiary mirror 23 includes a mirror unit 231, and it is formed with a fitting cavity 232 on a rear side thereof. The second supporting rod portion 212 of the supporting member 21 is fitted in the fitting cavity 232 of the second subsidiary mirror 23 at a tail end such that the second subsidiary mirror 23 can be changed in orientation in relation to the supporting member 21.

Therefore, the driver is allowed to adjust the first and the second subsidiary mirrors 22, and 23 such that he can see the blind areas, which can't be seen in the main mirror 1, in the first and the second subsidiary mirrors 22, and 23.

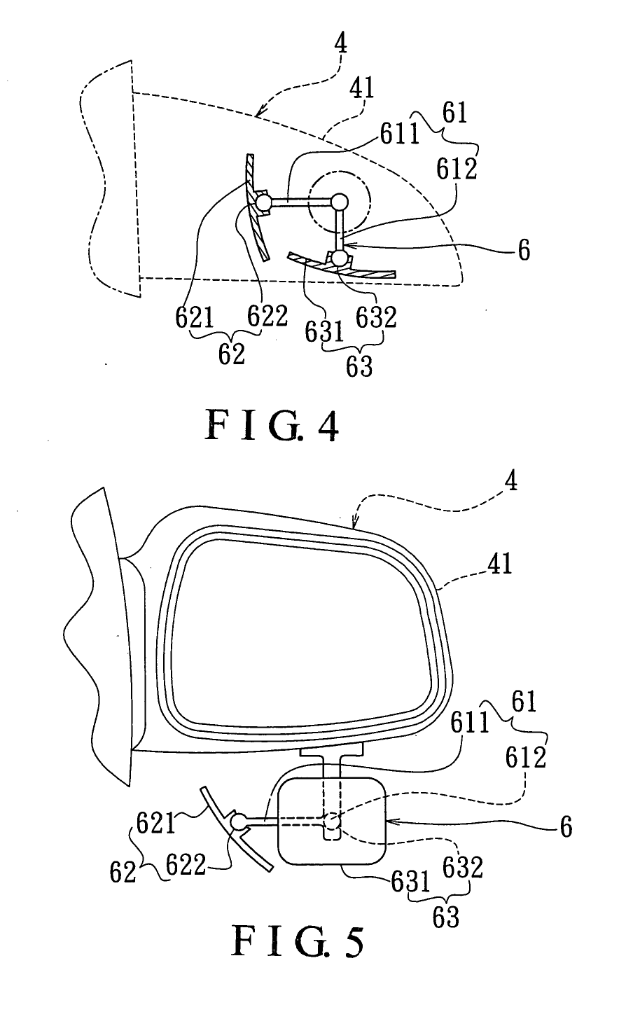

Referring to FIGS. 4, and 5, a second preferred embodiment of a side mirror includes a main mirror 4, and subsidiary twin mirrors 6. The main mirror 4 is held in a cover 41. The subsidiary twin mirrors 6 include a supporting member 61, a first subsidiary mirror 62 for imaging a front wheel of a car and an area near to the front wheel, and a second subsidiary mirror 63 for imaging a rear wheel of the car and an area near to the rear wheel. The supporting member 61 is secured to a lower side of the cover 41. The supporting member 61 includes first and second supporting rod portions 611, and 612 pointing in different directions. The first subsidiary mirror 62 includes a mirror unit 621, and it is formed with a fitting cavity 622 on a rear side thereof. The first supporting rod portion 611 of the supporting member 61 is fitted in the fitting cavity 622 of the first subsidiary mirror 62 at a tail end such that the first subsidiary mirror 62 can be changed in orientation. The second subsidiary mirror 63 includes a mirror unit 631, and it is formed with a fitting cavity 632 on a rear side thereof. The second supporting rod portion 612 of the supporting member 61 is fitted in the fitting cavity 632 of the second subsidiary mirror 63 at a tail end such that the second subsidiary mirror 63 can be changed in orientation.

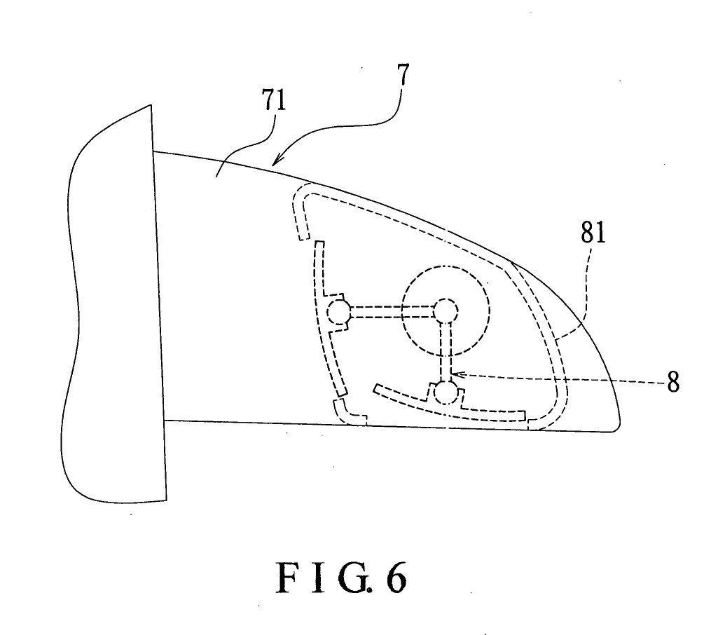

Referring to FIG. 6, a third preferred embodiment of a side mirror includes a main mirror 7, and subsidiary twin mirrors 8. The main mirror 7 is held in a cover 71. The subsidiary twin mirrors 8 have the same structure as the subsidiary twin mirrors 6 of the second preferred embodiment, and they are held in a cover 81, which is joined to a lower side of the cover 71 of the main mirror 7.

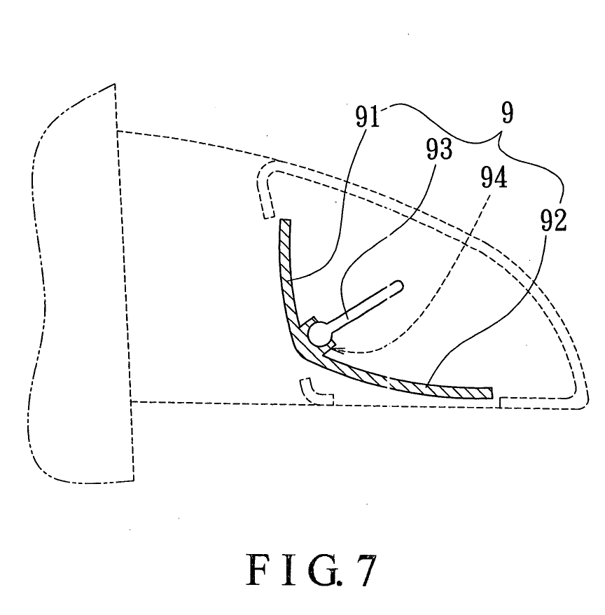

Referring to FIG. 7, the side mirror of the invention is equipped with another from of subsidiary twin mirrors 9 instead, which include a first subsidiary mirror 91 for imaging a front wheel of a car and an area near to the front wheel, a second subsidiary mirror 92 for imaging a rear wheel of the car and an area near to the rear wheel, and a supporting rod 93 secured to a lower side of a cover of a main mirror unit. The first and the second subsidiary mirrors 91, and 92 are joined together to be in an L-shape, and a fitting cavity 94 is formed on a rear side of the subsidiary mirrors 91 and 92. The supporting rod 93 is fitted in the fitting cavity 94 at a tail end such that the subsidiary mirrors 91, and 92 can be adjusted in orientation in relation to the supporting rod 93.

From the above description, it can be seen that the side mirror of the present invention has the following advantages:

1. The side mirror has the first and the second subsidiary mirrors for imaging blind areas in driving, e.g. front and rear wheels of the car and areas near to the front and the rear wheels, therefore the driver can prevent the car from running into obstacles when he is backing the car into a garage or a parking area.

2. Because the first subsidiary mirror of the side mirror images the blind area near to the front wheel of the car, the driver can prevent the car from running into obstacles when he is driving through a narrow road.

3. The first and the second subsidiary mirrors can be adjusted in orientation to image the blind areas in driving a car, which can't be seen in the main mirror by the driver.

What is claimed is:

1. An improvement on a side mirror, comprising
a main mirror; and
subsidiary twin mirrors; the subsidiary twin mirrors being positioned under the main mirror, near to an outward end portion of the main mirror; the subsidiary twin mirrors including:
(a) a supporting member;
(b) a first subsidiary mirror joined to and adjustable in orientation in relation to the supporting member for imaging a front wheel of a car and an area near to the front wheel; and
(c) a second subsidiary mirror joined to and adjustable in orientation in relation to the supporting member for imaging a rear wheel of the car and an area near to the rear wheel.

2. The side mirror as claimed in claim 1, wherein the supporting member is secured in place, and includes first and second supporting rod portions pointing in different directions, and each of the first and the second subsidiary mirrors includes a mirror unit, and has a fitting cavity on a rear side thereof; the first supporting rod portion of the supporting member being fitted in the fitting cavity of the first subsidiary mirror at a tail end such that the first subsidiary mirror is adjustable in orientation in relation to the supporting member; the second supporting rod portion of the supporting member being fitted in the fitting cavity of the second subsidiary mirror at a tail end such that the second subsidiary mirror is adjustable in orientation in relation to the supporting member.

3. The side mirror as claimed in claim 1, wherein the supporting member is secured in place, and has a supporting rod portion, and the first and the second subsidiary mirrors are joined together to be in an L-shape, and have a fitting cavity on a rear side thereof; the rod portion of the supporting member being fitted in the fitting cavity at a tail end such that, the subsidiary twin mirrors are adjustable in orientation in relation to the supporting member.

4. The side mirror as claimed in claim 1, wherein the main mirror and the subsidiary twin mirrors are held in a common cover.

5. The side mirror as claimed in claim 1, wherein the main mirror is held in a cover, and the subsidiary twin mirrors are positioned under the cover of the main mirror.

6. The side mirror as claimed in claim 1, wherein the main mirror is held in a cover, and the subsidiary twin mirrors are held in a second cover, which is secured under the cover of the main mirror.
